(19) United States
(12) Patent Application Publication
(10) Pub. No.: US 2022/0083857 A1
(43) Pub. Date: Mar. 17, 2022

(54) CONVOLUTIONAL NEURAL NETWORK OPERATION METHOD AND DEVICE

(71) Applicant: SigmaStar Technology Ltd., Fujian (CN)

(72) Inventors: Chao LI, Shanghai (CN); Wei ZHU, Shanghai (CN); Bo LIN, Shanghai (CN)

(21) Appl. No.: 17/401,358

(22) Filed: Aug. 13, 2021

(30) Foreign Application Priority Data
Sep. 15, 2020 (CN) 202010967566.7

(51) Int. Cl. G06N 3/08; G06F 7/544; G06F 7/523; G06F 7/50; G06F 7/32; G06F 9/48

(52) U.S. Cl. CPC G06N 3/08; G06F 7/5443; G06F 9/4881; G06F 7/50; G06F 7/32; G06F 7/523

(57) ABSTRACT

A convolutional neural network operation device includes a scheduling mode unit, a first data processing circuit, a second data processing circuit and a multiple-accumulate (MAC) operation array. The scheduling mode unit determines, according to a quantity and size information of the target convolutional kernels, a target scheduling mode corresponding to a size of a convolutional computing block. The first data processing circuit recombines weight data in the target convolutional kernels and the second data processing circuit recombines input data in a target convolutional layer according to the target scheduling mode. The MAC operation array includes multiple MAC operation cells, and performs a MAC operation based on the recombined weight data and the recombined input data, wherein a quantity of the MAC operation cells used by the MAC operation array in each round of operation corresponds to the size of the convolutional computing block.

This application claims the benefit of China application Serial No. CN202010967566.7, filed on Sep. 15, 2020, the subject matter of which is incorporated herein by reference.

### BACKGROUND OF THE INVENTION

### Field of the Invention

The invention relates to the technical field of data processing, and more particularly to a convolutional neural network operation and device.

### Description of the Related Art

Deep learning is one critical application technology for developing artificial intelligence, and is extensively applied in fields including computer vision and voice recognition. Convolutional neural networking (CNN) is a deep learning efficient recognition technology that has drawn much attention in the recent years. It performs convolution operations and vector operations of multiple layers with multiple feature filters by directly inputting original images or data, further generating highly accurate results in aspects of imaging and voice recognition.

However, the development and extensive application of convolutional neural networking also bring an increasing number of challenges. For example, a CNN model has an increasing scale of parameters and a more complex and varied network structure, and one CNN model usually includes multiple convolutional layers, with data of depths of individual convolutional layers and sizes of convolutional kernels being different. In a shallower layer in a CNN network, input data to be processed usually has a larger planar size and a smaller size in the channel direction; however, as the layer in the network gets deeper, some convolutional kernels may have greater depths in the channel directions, or the quantity of convolutional kernels in a convolutional layer may become larger. Thus, a multiply-accumulate (MAC) operation array consisting of multiple MAC cells in an electronic apparatus is faced with an enormous data amount for calculation. The processing capability provided by an electronic apparatus is frequently limited; that is, the maximum data amount that can be inputted into one round of operation of a MAC operation array is fixed. For example, assuming that the processing capability of a MAC operation array including multiple MAC operation units in an electronic apparatus is 256, the MAC array then includes 256 multipliers, that is, multiplication of 256 weight values and 256 corresponding sets of input data can be performed at most at a time. However, common input data is far greater than 256. Thus, convolutional kernels and input data need to be segmented into multiple blocks, for which operation is performed sequentially. In the prior art, the same method is adopted for segmenting convolutional layers and input data for different convolutional layers, and such approach does not effectively utilize hardware resources in an electronic apparatus. Therefore, there is a need for a solution for enhancing a resource utilization rate of a hardware accelerator during a calculation process.

### SUMMARY OF THE INVENTION

The present application provides a convolutional neural network (CNN) operation method and device in the aim of enhancing a resource utilization rate of a hardware accelerator.

The present application provides a CNN operation method applied to a CNN operation device, which includes multiply-accumulate (MAC) operation array including multiple MAC operation cells. The CNN operation method of the present application includes: determining a quantity of target convolutional kernels in a target convolutional layer and first size information of the target convolutional kernels; determining a target scheduling mode according to the quantity and the size information of the target convolutional kernels, wherein the target scheduling information corresponds to a size of a convolutional computing block; recombining weight data in the target convolutional kernels and outputting recombined weight data to the MAC operation array; recombining input data in the target convolutional layer and outputting recombined input data to the MAC operation array; and the MAC operation array performing a MAC operation based on the recombined weight data and the recombined input data; wherein, the quantity of the MAC operation cells used by the MAC operation array for each round of operation corresponds to the size of the convolutional computing block.

The present application further provides a convolutional neural network (CNN) operation device including a scheduling mode unit, a first data processing circuit, a second data processing circuit and an accumulate-multiply (MAC) operation array. The scheduling mode unit determines a target scheduling mode according to a quantity and first size information of target convolutional kernels. The first data processing circuit recombines weight data in the target convolutional kernels according to the target scheduling mode. The second data processing circuit recombines input data in a target convolutional layer according to the target scheduling mode. The MAC operation array includes multiple MAC cells, and performs a MAC operation based on the recombined weight data and the recombined input data. A quantity of the MAC operation cells used by the MAC operation array for each round of operation corresponds to the size of the convolutional computing block.

The CNN operation solutions provided by embodiments of the present invention are capable of dynamically adjusting a target scheduling mode for individual convolutional layers having different network structures in a CNN. Thus, each convolutional layer can adopt a scheduling mode that structurally matches the MAC operation array thereof to perform data block segmentation on input data to be processed and target convolutional kernels, so that weight values included in weight data and input data included in input data blocks after the segmentation can maximize utilization of operation resources of the MAC array, thereby in overall enhancing the resource utilization rate of a hardware accelerator and further improving the CNN operation speed.

### BRIEF DESCRIPTION OF THE DRAWINGS

To better describe the technical solutions of the embodiments of the present application, drawings involved in the description of the embodiments are introduced below. It is apparent that, the drawings in the description below represent merely some embodiments of the present application, and other drawings apart from these drawings may also be obtained by a person skilled in the art without involving inventive skills.

FIG. 1 is a flowchart of a convolutional neural network (CNN) operation method provided according to an embodiment of the present application;

FIG. 2 is a schematic diagram of a data structure of input data and convolutional kernels of a convolutional layer;

FIG. 3 is a schematic diagram of data segmentation of input data and convolutional kernels of a convolutional layer in one embodiment; and

FIG. 4 is a block diagram of a CNN operation device provided according to an embodiment of the present invention applied to an electronic apparatus.

### DETAILED DESCRIPTION OF THE INVENTION

The technical solutions of the embodiments of the present application are clearly and thoroughly described with the accompanying drawings of the embodiments of the present application below. It is apparent that the described embodiments are merely some but not all implementation examples of the present application. In the description below, the same denotations and numerals represent the same elements, and examples of the present invention are described by way of implementations in an appropriate application environment. On the basis of the embodiments of the present application, all other embodiments obtained by a person skilled in the art without involving any inventive skills are to be encompassed within the scope of protection of the present application.

A convolutional neural network (CNN) operation method is provided according to an embodiment of the present application. The execution entity of the CNN operation method may be a CNN operation device provided according to an embodiment of the present application, or an electronic apparatus integrated with the CNN operation device. In practice, the CNN operation device may be implemented in the form of hardware, software, or hardware combined with software.

The CNN operation solutions provided by the embodiments of the present application are applicable to a CNN in any structure, for example, to a CNN having only one convolutional layer, or to some more complex CNNs such as a CNN having a hundred or more convolutional layers. Further, the CNN of the embodiments of the present application may include a pool layer and a fully connected layer. That is to say, the solutions of the embodiments of the present application are not limited to specific types of CNNs, and any neural network including a convolutional layer may be regarded as a “CNN” of the present application, and operations may be performed on the convolutional layer(s) thereof according to the embodiments of the present application.

It should be noted that, the CNN of the embodiment of the present invention is applicable to numerous scenarios, for example, fields of image recognition such as face recognition and license plate recognition, fields of feature extraction such as image feature extraction and voice feature extraction, fields of voice recognition and fields of natural language processing. Images or feature data obtained from converting data in other forms is inputted to a pre-trained CNN, and operations can then be performed using the CNN, so as to achieve an object of classification, recognition or feature extraction.

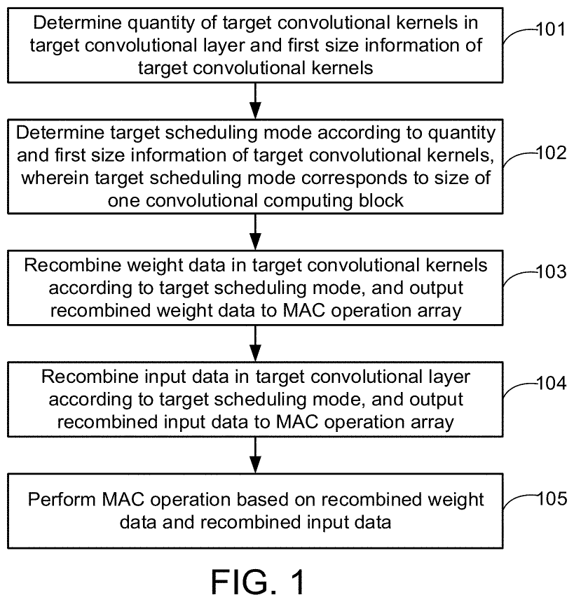

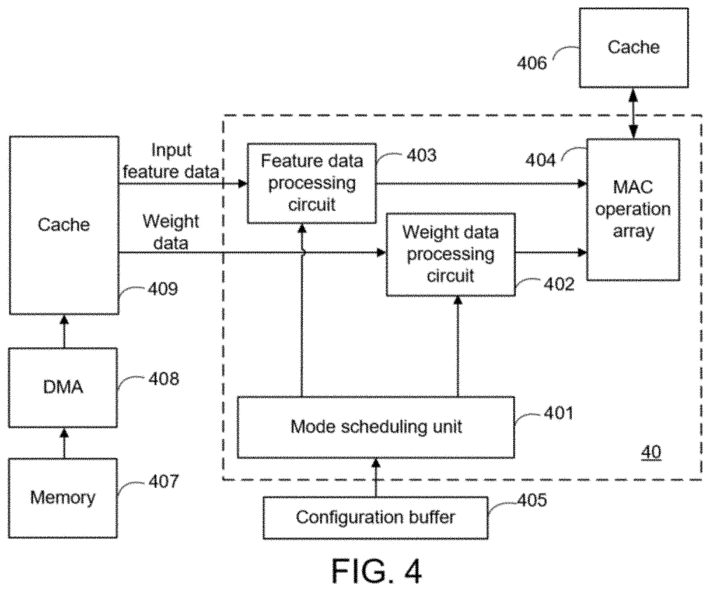

FIG. 1 shows a flowchart of a CNN operation method provided according to an embodiment of the present application. FIG. 4 shows a block diagram of a CNN operation device provided according to an embodiment of the present application applied to an electronic apparatus. Referring to FIG. 1 and FIG. 4, a CNN operation device 40 can be used to implement the CNN operation method in FIG. 1. Specific steps of the CNN operation method and the operation of the CNN operation device 40 are described below.

In step 101, a quantity of target convolutional kernels in a target convolutional layer and first size information of the target convolutional kernels are determined.

For an electronic apparatus integrated with a CNN operation device, a convolutional layer performs a convolutional operation on input data and convolutional kernel data to obtain output data. The input data may be raw images, voice data or data outputted by a previous convolutional layer or pool layer, and input data in a CNN operation device is commonly feature data. Thus, the input data of the CNN operation device 40 may be feature data of a target convolutional layer.

Input data may have multiple channels, and the input data on each channel may be understood as one set of two-dimensional data. When the channel count of input data is greater than 1, the input data may be understood as three-dimensional data as a result of overlaying two-dimensional data of multiple channels, and the depth of the three-dimensional data is equal to the channel count. The target convolutional layer (that is, the convolutional layer currently to undergo a convolutional operation) may include one or more convolutional kernels. A convolutional kernel is also referred to as a filter, and the channel count of each convolutional kernel is equal to the channel count of the input data of that layer. That is to say, after performing a convolutional operation on the input data and the data of one convolutional kernel, a set of two-dimensional data is obtained; for a target convolutional layer having multiple convolutional kernels, the binary data outputted according to the individual convolutional kernels is added up to obtain one set of three-dimensional data.

When an operation is performed based on a CNN, a mode scheduling unit 401 determines a target convolutional layer from a CNN current used for the operation. In practice, the mode scheduling unit 401 may obtain information related to the target convolutional layer from a configuration buffer 405, for example, learning from the configuration buffer 405 information such as which being the target convolutional layer, the quantity of convolutional kernels thereof, a planar size of the convolutional kernels thereof, and depth information in the channel direction.

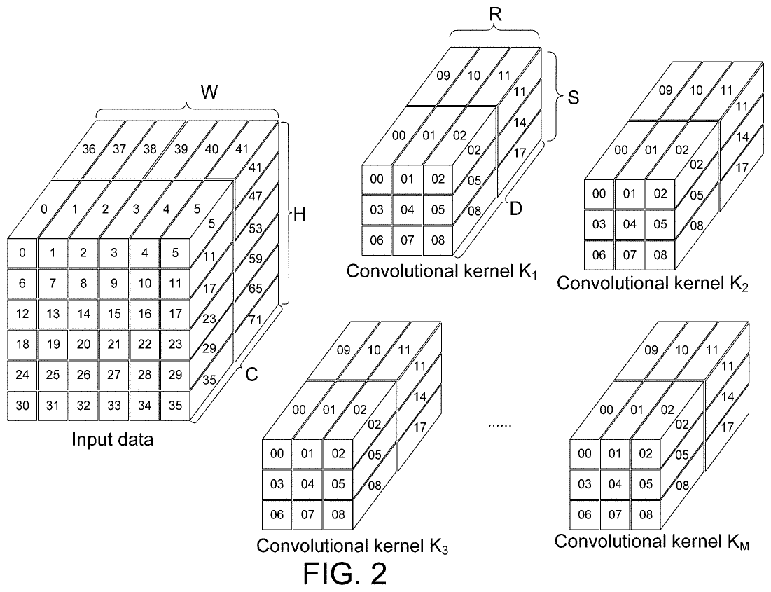

FIG. 2 shows a schematic diagram of a data structure of input data and convolutional kernels of one convolutional layer. Referring to FIG. 2, the convolutional layer in FIG. 2 includes M convolutional kernels, which are K1, K2, K3, . . . and KM, respectively. The sizes of the M convolutional kernels are equal, and are all D×R×S. As shown, D represents the depth in the channel direction, and R×S represents the size in the planar direction. The size of the input data is C×W×H, where C represents the depth of the input data in the channel direction and C=D in practice, and W×H represents the size of the input data in the planar direction.

Since the sizes and quantities of convolutional kernels in the individual convolutional layers may be different, in the embodiment of the present application, to perform an operation on the target convolutional layer, the quantity of the target convolutional kernels and information such as the size and/or depth of the target convolutional layers are first determined.

In step 102, a target scheduling mode is determined according to the quantity and the first size information of the target convolutional kernels, wherein the target scheduling mode corresponds to a size of a convolutional computing block.

When the number of MAC operation cells in a MAC operation array is limited while the number of parameters in the convolutional layer (for example, the data amount of convolutional kernels) is enormous, numerous rounds of operation using the MAC operation array may need to be performed in order to complete the entire operation for one convolutional layer. Thus, the convolutional kernels and input data need to be segmented into multiple blocks, weight data blocks in a certain quantity and input data blocks in a corresponding quantity are inputted into the MAC operation array, and then the MAC operation is performed. To effectively utilize the operation resources of the MAC operation array 404, the mode scheduling unit 401 may determine a target scheduling mode according to the quantity and related size information of the convolutional kernels. In practice, the mode scheduling unit 401 may select a target scheduling mode from multiple predetermined scheduling modes according to the quantity and related size information of the target convolutional kernels, each scheduling mode corresponds to the size of a specific convolutional computing block, the convolutional computing block is a minimum unit for performing the convolutional operation, and the target scheduling mode selected by the mode scheduling unit 401 may enable most effective utilization of the MAC operation array 404. For example, when the CNN operation device 40 operates in the target scheduling mode, the MAC operation array 404 may complete the MAC operation on the input data and the target convolutional kernels using a least number of rounds of operation.

In one embodiment, the size of the convolutional computing block corresponding to the scheduling mode may be the size of a data block of m weight data blocks in a size of d×w×h from m target convolutional kernels in one round of operation performed by the MAC operation array 404, where d represents the depth of the weight data block in the channel direction, w×h is the size of the weight data block in the planar direction, and m, d, w and h are all positive integers. Configuring a predetermined scheduling mode may be regarded as configuring specific values of m, d, w and h, and various factors need to be comprehensively considered.

First of all, the processing capability of the MAC operation array 404 of the electronic apparatus needs to be considered, that is, the quantity of MAC operation cells in the MAC operation array 404 needs to be taken into account. For example, assuming that the MAC operation array 404 includes a total of 256 MAC operation cells, 256 MAC operations can be performed at most at the same time in one round of operation. Thus, when m weight data blocks in a size of d×w×h are obtained from m target convolutional kernels in one round of operation of the MAC operation array, the values of m, d, w and h need to meet: m×d×w×h≤256.

Secondly, actual network requirements need to be considered. For example, with respect to the sizes and quantities of convolutional kernels in the convolutional layer, the size of some convolutional kernels is 1×1×64 while the size of some convolutional kernels is 11×11×3, and some convolutional layers may have 8 convolutional kernels while some convolutional layers may have 2048 convolutional kernels. With comprehensive consideration of the parameters above, convolutional computing blocks in different sizes are configured so as to adapt to different network layers.

For example, given a fixed processing capability of the MAC operation cells, that is, under the condition of m×d×w×h≤256, when the convolutional kernels of a convolutional layer are larger in quantity and smaller in depth, the value of m may be configured to be larger and the value of d may be configured to be smaller, for example, m=64, d=4, w=1 and h=1, or m=16, d=16, w=1 and h=1. Conversely, when the convolutional kernels of a convolutional layer are smaller in quantity and greater in depth, the value of m may be configured to be smaller and the value of d may be configured to be larger, for example, m=1, d=32, w=3 and h=3. Alternatively, for some convolutional kernels in special sizes, special configurations may also be made, for example, for 3×3 convolutional kernels, m=1 d=32, w=3 and h=3 may be configured. In this case, although 100% utilization efficiency of the computing resources of the MAC operation cells cannot be ensured, the utilization rate is however maximized. Again referring to FIG. 2, the convolutional layer in FIG. 2 includes M convolutional kernels, and in this example, m is preferably a positive factor of M, that is, M is an integer multiple of m.

In practice, the quantities and sizes of the convolutional kernel layers of individual convolutional layers may be first evaluated in advance to determine most appropriate sizes of convolutional computing blocks, then numerous predetermined scheduling modes are then provided in advance, and a lookup data is established in a memory, wherein the lookup table includes the mapping relationship between the parameters of the convolutional kernels and the predetermined scheduling modes. The mode scheduling unit 401 may find the target scheduling mode from the lookup table according to the quantity and related size information of the target convolutional kernels. In one embodiment, the mode scheduling unit 401 may be implemented by a processor executing a program code, information of the data amount of the input data of the target convolutional layer and quantity and size information of the convolutional kernels are stored in the configuration buffer 405, and the mode scheduling unit 401 obtains the quantity and related size information of the target convolutional kernels from the configuration buffer 405.

As shown in FIG. 4, the CNN operation device 40 fetches the weight values and input data need for each round of operation from a memory 407 through a cache 409 during the process of the convolutional operation, and an intermediate result generated during the process of the operational operation by the MAC operation array 404 is buffered in a cache 406. For an electronic apparatus, the storage space allocated for the use of a convolutional operation is limited. Thus, for this reason, when the scheduling mode is predetermined, in addition to considering the network structure, the occupancy conditions of a storage space needs to be further taken into account when the scheduling mode above is used so as to configure appropriate scheduling modes. Therefore, in one embodiment, the mode scheduling unit 401 determines the target scheduling mode also according to the capacity of the cache 409 and/or the cache 406.

In step 103, the weight data in the target convolutional kernels is recombined according to the target scheduling mode, and the recombined weight data is outputted to the MAC operation array 404.

After the target scheduling mode is determined, the weight data processing circuit 402 segments and appropriately recombines the weight data in the target convolutional kernels according to the target scheduling mode, so that the recombined weight data can be inputted according to an appropriate sequence to the MAC operation array 404, and the MAC operation array 404 can complete the required convolutional operation.

In practice, the weight data in the target convolutional kernels may be stored in the memory 407, and the weight data processing circuit 402 may read, under the control of a direct memory access (DMA) controller 408 through the cache 409, the weight data from the memory 407.

In one embodiment, for each scheduling mode, the weight data processing circuit 402 is configured with a corresponding operating setting for reading and recombining the weight data. Once the target scheduling mode is determined, the weight data processing circuit 402 reads and recombines the weight data in the target convolutional kernels using the corresponding operation setting according to the target scheduling mode. In practice, the weight data processing circuit 402 may write the weight data in the target convolutional kernels according to an original sequence, and then read the weight data from the cache according to a required sequence, hence achieving the object of recombining and resorting the weight data.

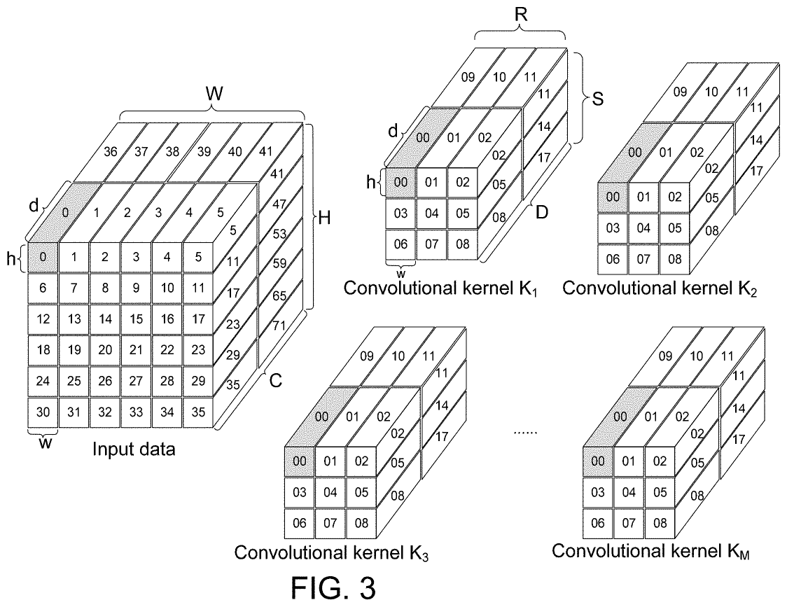

FIG. 3 shows a schematic diagram of segmenting input data and data of convolutional kernels of a convolutional layer according to an embodiment. Referring to FIG. 3, once the target scheduling mode is determined, assuming that the size of a convolutional computing block corresponding to the target scheduling mode is m×d×w×h, that is, in one round of operation of the MAC operation array 404, the weight data processing circuit 402 reads m weight data blocks in a size of d×w×h from the target convolutional kernels, and inputs the recombined weight data to the MAC operation array 404. More specifically, the weight data processing circuit 402 obtains m weight data blocks from the m convolutional kernels including K1, K2, . . . and Km, wherein each of the weight data blocks has a depth of d in the channel direction and a planar size of w×h.

In step 104, the input data in the target convolutional layer is recombined according to the target scheduling mode, and the recombined input data is outputted to the MAC operation array.

After the target scheduling mode is determined, a feature data processing circuit 403 segments and appropriately recombines data of the input data in the target convolutional layer according to the target scheduling mode, so that the recombined weight data is inputted to the MAC operation array 404 according to a sequence matching the corresponding weight blocks, thus completing the required convolutional operation.

In practice, the input data in the target convolutional layer may be stored in the memory 407, and the feature data processing circuit 403 may read, under the control of the DMA through the cache 409, the input data from the memory 407.

Similarly, for each scheduling mode, the feature data processing circuit 403 is configured with a corresponding operation setting for reading and recombining input data. Once the target scheduling mode is determined, the feature data processing circuit 403 reads and recombines the input data in the target convolutional layer by using the corresponding operation setting according to the target scheduling mode. In practice, the feature data processing circuit 403 may also write the input data in the target convolutional layer to a cache according to an original sequence, and then read the input data from the cache according to a required sequence, for example, reading the input data from the cache according to a data sequence matching the corresponding weight data blocks, thus achieving the object of recombining and resorting the input data.

Again referring to FIG. 3, the feature data processing circuit 403 in the embodiment in FIG. 3 segments the input data in the target convolutional layer into multiple input data blocks in a size of d×w×h, and recombines each set of input data, so that the data sequence of the recombined input data blocks can match the corresponding weight data blocks, and the MAC operation array 404 can accordingly complete the correct MAC operation.

In step 105, a MAC operation is performed based on the recombined weight data and the recombined input data.

The MAC operation array 404 performs a MAC operation based on the recombined weight data and the recombined input data, wherein the quantity of the MAC operation cells used by the MAC operation array 404 in each round of operation corresponds to the size of the convolutional computing block.

After performing one round of operation, the MAC operation array 404 uses and stores the calculation result as intermediate data in the cache 406. When performing a MAC operation, the MAC operation array 404 adds and stores products of the same convolutional kernel in the channel direction as intermediate data. Then, the weight data processing circuit 402 continues to read the weight data blocks from the cache 409 according to the sequence of the convolutional operation on the input data of the convolutional kernel, the feature data processing circuit 403 reads and recombines the input data from the cache 409, so as to output input data blocks matching the weight data blocks, and the MAC operation array 404 accordingly performs another round of operation. The above is cyclically performed until the operation of each data block in the input data with the weight blocks is complete.

A specific application scenario is given as an example for illustrating the present application below. Referring to FIG. 3, assume that C=32, W=6, H=6, D=32, R=3, S=3, M=16, d=16, m=16, w=1 and h=1. As shown, the input data can be segmented into 72 input blocks, and one convolutional kernel can be segmented into 18 weight data blocks. Assuming that the stride corresponding to the convolutional kernel is 1, and zero padding in a length of 2 is performed in both lengthwise and widthwise directions, all the 36 input data blocks numbered 0 to 35 of the input data need to undergo an inner production operation with the weight data corresponding to 00 in each convolutional kernel.

For example, the feature data block 0 in a size of 16×1×1 (the gray block of the input data in FIG. 3) in the input data needs to undergo with an inner production operation with the weight data block 00 (the gray block in the convolutional kernel in FIG. 3) in a size of 16×1×1 in each convolutional kernel. Thus, the weight data processing circuit 402 reads the first weight data block from each of the 16 convolutional kernels in the cache according to the size of the convolutional computing block (d=16, m=16, w=1 and h=1) corresponding to the target scheduling module, and obtains 16 weight data blocks 00 in a size of 16×1×1. The feature data processing circuit 403 reads the input data block 0 in a size of 16×1×1 from the input data, and individually matches the input data block 0 with the 16 weight data blocks 00 (that is to say, the input data block 0 is repeatedly used for 16 times in one round of operation of the MAC operation array 40, and is equivalent to 256 sets of data). The input data block 0 and the 16 weight data blocks 00 are inputted to the MAC operation array 404 for operation to obtain 16 values (the products in the channel direction are added) that are stored as intermediate results; the process above is one round of operation of the MAC operation array 404. Then, data is read for the second time so as to perform a 2^{nd} round of operation of the MAC operation array 404. As described above, the 36 sets of input data numbered 0 to 35 in the input data need to undergo an inner product operation with the weight data blocks 00 in each convolutional kernel. Thus, when data is read for the second time, the weight data block 00 does not need to be repeated read, and the input data 0 in a size of 16×1×1 is read from the input data, the input data block 1 is individually matched with the 16 sets of weight data 00, and the operation is performed using the MAC operation array 404 to obtain 16 values that are also stored as intermediate results. Next, according to the same manner of data reading as the 2^{nd} round of operation, an input data block 2 in a size of 16×1×1 is read, a 3^{rd} round of operation of the MAC operation array 404 is performed, and according to the same manner of data reading as the 2^{nd} round of operation, an input data block 35 in a size of 16×1×1 is read, a 36th round of operation of the MAC operation array 404 is performed. At this point, the convolutional operation of the input data and the weight data blocks 00 is complete, and 36 sets of intermediate results are stored, wherein each set of intermediate result contains 16 values.

Next, in the 37th round of operation, 16 weight data blocks 01 in a size of 16×1×1 are read from the cache, one input data block 0 in a size of 16×1×1 is read from the input data, the input data block 0 is individually matched with the 16 weight data blocks 01, and an operation is performed by the MAC operation array 40 to obtain 16 values. Since all these 16 values and the 16 values obtained in the 1^{st} round of operation correspond to the input data blocks 0 in the input data, these 16 values need to be respectively added with the 16 values obtained in the 1st round of operation to obtain 16 new values that are stored as new intermediate results that overwrite the 16 intermediate results stored in the 1^{st} round of operation. According to the same manner of data reading as the previous 36 times, the MAC operation array 404 performs the 37^{th} to the 72^{nd} rounds of operation, thus completing the convolutional operation of the input data and the weight data blocks 01.

The operation process above is repeated until all the convolutional operation of all input data of the target convolutional kernel is complete to obtain 16 sets of two-dimensional output data, and these 16 sets of two-dimensional output data are added up to obtain three-dimensional output data of the target convolutional layer. If the next layer is also a convolutional layer, the output data can be read to a cache and serve as input data for the operation of the next layer for the continued convolutional operation.

It should be noted that, the description above discloses a specific embodiment for one to better understand the solutions of the present application. In this embodiment, the number of weight values read once is larger than the number of sets of input data, and so when repeated weight values are used by two successive rounds of operation, weight data blocks are not repeatedly read so as to enhance data processing efficiency. However, the example above does not impose a limitation on the solutions of the present application. In other embodiments, data may be read according to other sequences, and data blocks may or may not be repeatedly read when the data is read according to other sequences.

In practice, the present application is not limited by the sequence of performing the steps described, and some of the steps may be performed according to other sequences or be performed simultaneously, given that no conflicts are incurred.

In conclusion, the CNN operation method provided according to the embodiment of the present application is capable of dynamically adjusting a target scheduling mode for individual convolutional layers having different network structures in the CNN. Thus, each convolutional layer can adopt a scheduling mode that structurally matches the MAC operation array thereof to perform data block segmentation on input data to be processed and target convolutional kernels, so that weight values included in weight data and the quantity of input data included in input data blocks after the segmentation can maximize utilization of operation resources of the MAC array, thereby in overall enhancing the resource utilization rate of a hardware accelerator and further improving the CNN operation speed.

The CNN operation method and device provided according to embodiments of the present application are as described above. The principle and implementation details of the present application are described by way of specific examples in the literature, and the illustrations given in the embodiments provide assistance to better understand the method and core concepts of the present application. Variations may be made to specific embodiments and application scopes by a person skilled in the art according to the concept of the present application. In conclusion, the disclosure of the detailed description is not to be construed as limitations to the present application.

What is claimed is:

1. A convolutional neural network (CNN) operation method, applied to a CNN operation device, the CNN operation device comprising a multiply-accumulate (MAC) operation array, the MAC operation array comprising a plurality of MAC operation cells, the CNN operation method comprising:
determining a quantity of target convolutional kernels in a target convolutional layer and first size information of the target convolutional kernels;
determining a target scheduling mode according to the quantity and the first size information of the target convolutional kernels, wherein the target scheduling mode corresponds to a size of a convolutional computing block;
recombining weight data in the target convolutional kernels according to the target scheduling mode, and outputting recombined weight data to the MAC operation array;
recombining input data in the target convolutional layer according to the target scheduling mode, and outputting recombined input data to the MAC operation array; and
the MAC operation array performing a MAC operation based on the recombined weight data and the recombined input data, wherein a quantity of the MAC operation cells used by the MAC operation array in each round of operation corresponds to the size of the convolutional computing block.

2. The CNN operation method according to claim 1, wherein the target scheduling mode corresponds to a least number of rounds of operation completed on the input data and the target convolutional kernels by the MAC operation array.

3. The CNN operation method according to claim 1, wherein the first size information comprises depth information of the target convolutional kernels in a channel direction.

4. The CNN operation method according to claim 1, wherein the target scheduling mode is selected from a plurality of predetermined scheduling modes.

5. The CNN operation method according to claim 1, wherein the MAC operation array stores intermediate data to a cache, and the step of determining the target scheduling mode determines the target scheduling mode further according to a capacity of the cache.

6. The CNN operation method according to claim 1, wherein a quantity of the target convolutional kernels is M, the size of the convolutional computing block is an integer multiple of m, M is an integer multiple of m, and both M and m are positive integers.

7. The CNN operation method according to claim 1, wherein the step of recombing the input data in the target convolutional layer matches the recombined input data with the recombined weight data.

8. A convolutional neural network (CNN) operation device, for performing a convolutional operation on target convolutional kernels and input data in a target convolutional layer, the CNN operation device comprising:
a scheduling mode unit, determining a target scheduling mode according to a quantity and first size information of the target convolutional kernels, wherein the target scheduling mode corresponds to a size of a convolutional computing block;
a first data processing circuit, recombining weight data in the target convolutional kernels according to the target scheduling mode;
a second data processing circuit, recombining input data in the target convolutional layer according to the target scheduling mode; and
a multiply-accumulate (MAC) operation array, comprising a plurality of MAC operation cells, the MAC operation array performing a MAC operation based on the recombined weight data and the recombined input data, wherein a quantity of the MAC operation cells used by the MAC operation array in each round of operation corresponds to the size of the convolutional computing block.

9. The CNN operation device according to claim 8, wherein the target scheduling mode corresponds to a least number of rounds of operation completed on the input data and the target convolutional kernels by the MAC operation array

10. The CNN operation device according to claim 8, wherein the first size information comprises depth information of the target convolutional kernels in a channel direction.

11. The CNN operation device according to claim 8, wherein the target scheduling mode is selected from a plurality of predetermined scheduling modes.

12. The CNN operation device according to claim 11, wherein the plurality of predetermined scheduling modes are stored in a memory.

13. The CNN operation device according to claim 8, wherein the MAC operation array stores intermediate data in a cache, and the mode scheduling unit determines the target scheduling mode further according to a capacity of the cache.

14. The CNN operation device according to claim 8, wherein a quantity of the target convolutional kernels is M, the size of the convolutional computing block is an integer multiple of m, M is an integer multiple of m, and both M and m are positive integers.

15. The CNN operation device according to claim 8, wherein the first data processing circuit recombines data by writing and reading the weight data of the target convolutional kernels to and from a cache.
